(19) United States
(12) Patent Application Publication
(10) Pub. No.: US 2026/0093925 A1
(43) Pub. Date: Apr. 2, 2026

(54) Multiple Sensor Data Processing for Improved Semantics and Generative Artificial Intelligence

(71) Applicant: Apple Inc., Cupertino, CA (US)

(72) Inventors: Dan C Lelescu, Grandvaux (CH); James M Graham, San Jose, CA (US); Bosheng Zhang, Los Altos, CA (US); Todd G Bell, Capitola, CA (US)

(21) Appl. No.: 19/338,140

(22) Filed: Sep. 24, 2025

Related U.S. Application Data
(60) Provisional application No. 63/700,289, filed on Sep. 27, 2024.

(51) Int. Cl. G06F 40/30

(52) U.S. Cl. CPC G06F 40/30

(57) ABSTRACT

Techniques are disclosed herein to perform improved semantics generation and generative artificial intelligence (GenAI) techniques leveraging multi-sensor signal processing and semantic processing (e.g., in the embedded domain and/or the natural language domain), in order to improve user/device interactions. For example, the output signals from one or more device sensors may be temporally sampled and synchronized. Then, if a sufficiently significant change is detected in any sensor signal over a period of time, e.g., in embedded space or otherwise, the device may decode the relevant embeddings reflecting the significant change and bundle those semantics with any other contemporaneous interpreted semantics for submission to a large language model (LLM). The LLM may then fuse the multi-modal semantic information and produce a final semantic output, e.g., in the form of a natural language output or a programmatic decision output (e.g., a classification of an environment or a command sent directly to another device(s)).

### TECHNICAL FIELD

This disclosure relates generally to the fields of user/device interactions, machine learning, and signal processing. More particularly, but not by way of limitation, it relates to performing improved semantics generation and generative artificial intelligence (GenAI) techniques leveraging multi-sensor machine learning techniques, in order to improve user/device interactions and experiences.

### BACKGROUND

The advent of portable integrated computing devices has caused a wide proliferation of compact cameras and other video capture-capable devices. These integrated computing devices commonly take the form of smartphones, tablets, wearables (e.g., smart watches or head-mounted display (HMD) devices), or laptop computers, and typically include general purpose computers, cameras, various sensors, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices'capabilities to perform tasks that would otherwise have required dedicated, task-specific hardware and software in the past.

For example, portable integrated computing devices, such as smartphones, tablets, wearables, and laptops typically have one or more embedded (i.e., integrated) cameras. These cameras generally amount to lens/camera hardware modules that may be controlled through the use of a general-purpose computer using firmware and/or software (e.g., applications, or “apps”) and a user interface, including touch-screen buttons, fixed buttons, and/or touchless controls, such as gestures or voice control. The placement of such cameras and other device sensors (e.g., microphones, inertial measurement units (IMUs), ambient light sensors (ALSs) LiDAR scanners, etc.) into these portable integrated computing devices has enabled users to capture and share images and videos of their surroundings—and for such devices to understand their surroundings—in ways never before possible, thereby allowing for a new array of more sophisticated and intelligent user/device interactions.

### SUMMARY

Devices, methods, and non-transitory computer-readable media (CRM) are disclosed herein to perform improved semantics generation and generative artificial intelligence (GenAI) techniques leveraging multi-sensor signal processing, in order to improve user/device interactions.

For example, the output signals from one or more image and/or non-image sensors in communication with a device may be temporally sampled and synchronized with each other. Then, for each sensor data signal, and depending on the signal type, the sampled data may either be: directly represented in embedded space in the form of embeddings; decoded and then re-encoded to generate new embeddings; and/or, e.g., for some non-image sensors (such as IMUs), interpreted directly using a computational model to generate semantics, such as “walking,” “climbing,” etc. In some cases, an encoding may or may not be directly suitable for making similarity decisions in embedded space, and therefore it may need to be decoded, or re-projected, e.g., by a machine learning model, in a form that is suitable for performing similarity operations across multiple sensor observations. In other cases, it may be more preferential to reason about what the sensor(s) have observed in the natural language domain (e.g., using an LLM), in which case what was encoded in the embedded space may be decoded (i.e., interpreted) in the natural language domain.

If a sufficiently significant change (e.g., an amount of change exceeding a threshold value(s)) is detected in the semantic data over a period of time, e.g., via processing and comparison in the embedded space, in the original signal domain, and/or in semantic space (again, depending on the type of sensor data being analyzed), the device may, at that time, decode any embeddings from sensors where the significant change was detected in the embedded domain and bundle those semantics with any other contemporaneous interpreted semantics to submit to a large language model (LLM) or other GenAI tool, e.g., in the form of a prompt. According to some such examples, before submission to the LLM, the device may also detect and filter out any likely “hallucinations” in the semantic data, such that only the semantic information that is likely to be “valid” is bundled and submitted to the LLM at any given time. (In other embodiments disclosed herein, the interpretation of the filtered semantics may be done directly in the embedded space, i.e., not submitting the semantics to the text domain to be further processed/fused by the LLM.)

The LLM may then be configured to fuse the multi-modal semantic information and produce a final semantic output (i.e., a form of GenAI), which can be: (1) provided to the user in the direct form of context (e.g., information about the environment's composition, activities in the environment, or activities being performed by the user, etc.); (2) presented in the form of a decision, such as a classification of environment type (e.g., “kitchen”); or (3) provided to an automated process (e.g., in the form of a command submitted to an Internet of Things (IoT) device, or the like).

Thus, according to one embodiment, a device is disclosed, comprising: a memory; one or more image sensors; and one or more processors operatively coupled to the memory, wherein the one or more processors are configured to execute instructions causing the one or more processors to: sample data captured by the one or more image sensors over a first period of time to produce sampled image sensor data; obtain a first set of encoded features for first semantic information associated with the sampled image sensor data; determine, based on a comparison of the first set of encoded features to a second set of encoded features for second semantic information associated with sampled data captured prior to the first time period, that there has been at least one change in the first semantic information that exceeds a threshold value; submit, in response to determining that there has been at least one change in the first semantic information that exceeds a threshold value, at least a portion of the first semantic information in the form of a prompt to a large language model (LLM); and perform an action at the device based, at least in part, on an output from the LLM produced in response to the submitted prompt.

According to some embodiments, the device further comprises one or more non-image sensors, wherein the one or more processors are further configured to execute instructions causing the one or more processors to: sample data captured by the one or more non-image sensors over the first period of time to produce sampled non-image sensor data; and obtain a third set of encoded features for third semantic information associated with the sampled non-image image sensor data, wherein the instructions causing the one or more processors to determine, based on a comparison of the first set of encoded features to a second set of encoded features for second semantic information associated with sampled data captured prior to the first time period, that there has been at least one change in the first semantic information that exceeds a threshold value further comprise instructions causing the one or more processors to: determine, based on a comparison of the first set of encoded features and the third set of encoded features to the second set of encoded features, that there has been at least one change in the first semantic information or the third semantic information that exceeds a threshold value, and wherein the instructions causing the one or more processors to submit, in response to determining that there has been at least one change in the first semantic information that exceeds a threshold value, at least a portion of the first semantic information in the form of a prompt to an LLM further comprise instructions causing the one or more processors to: submit, in response to determining that there has been at least one change in the first semantic information or the third semantic information that exceeds a threshold value, at least a portion of the first semantic information or the third semantic information as part of a prompt to an LLM.

According to some such embodiments, the instructions causing the one or more processors to submit, in response to determining that there has been at least one change in the first or third semantic information that exceeds a threshold value, at least a portion of the first or third semantic information in the form of a prompt to a large language model (LLM) further comprise instructions causing the one or more processors to: filter out at least a second portion of the first or third semantic information based, at least in part, on a determination that the at least second portion of the first or third semantic information comprises hallucinated semantic information.

According to some embodiments, the LLM comprises a multimodal LLM (i.e., an LLM capable of processing and understanding information across various modalities, such as image data, text data, audio data, etc.).

According to some embodiments, the one or more processors are further configured to execute instructions causing the one or more processors to: pre-process the sampled sensor data based on the nature of the training data and methods used to train a first encoder network, wherein the pre-processing occurs prior to using the first encoder network to produce the first set of encoded features.

According to some embodiments, the one or more processors are further configured to execute instructions causing the one or more processors to: process the sampled image sensor data captured by the one or more image sensors over a first period of time using at least one image processing technique prior to using a first encoder network to produce the first set of encoded features.

According to some embodiments, the instructions causing the one or more processors to sample data captured by the one or more image sensors over a first period of time further comprise instructions causing the one or more processors to: crop the data captured by the one or more image sensors based on at least one of: an estimated attention of a user of the device during the first period of time; or a region of interest (ROI) identified in the data captured by the one or more image sensors.

According to some embodiments, the data captured by the one or more image sensors over the first period of time comprises: still images, video segments, or a combination thereof.

According to some embodiments, the first set of encoded features is produced, at least in part, by applying one or more constraints to the first semantic information based on the second set of encoded features.

According to some embodiments, the action comprises at least one of: a natural language output; or a programmatic decision output.

According to some embodiments, the first semantic information comprises at least one of: textual information; or semantic information encoded in an embedded space.

According to some embodiments, the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to: filter out at least a second portion of the first semantic information from the submission to the LLM based on the second portion of the first semantic information being at least one of: noisy, inaccurate, or redundant.

According to some embodiments, the instructions causing the one or more processors to sample data captured by the one or more image sensors over a first period of time further comprise instructions causing the one or more processors to perform at least one of the following: sample data captured by the one or more image sensors at a regular time interval; sample data captured by the one or more image sensors at an irregular time interval; or sample data captured by the one or more image sensors in response to one or more detected conditions at the device.

According to some embodiments, the one or more processors are further configured to execute instructions causing the one or more processors to: determine, based on at least one signal, when during the first time period to sample from data captured by the one or more image sensors; and determine, based on at least one signal, when during the first time period to sample from data captured by the one or more non-image sensors. (For example, data could be sampled form a sensor based on a certain type of motion being detected, a certain sound being recorded, a change in illumination level, a semantic change detected by another sensor, etc.).

According to some embodiments, the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to: constrain an output from the LLM produced in response to the prompt based on at least one external ontology.

According to some embodiments, the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to: filter out at least a second portion of the first semantic information based, at least in part, on a determination that the at least second portion of the first semantic information comprises hallucinated semantic information.

According to some embodiments, a non-transitory program storage device id disclosed, comprising instructions stored thereon to cause one or more processors to: sample data captured by one or more image sensors of a device over a first period of time to produce sampled image sensor data; sample data captured by one or more non-image sensors of the device over the first period of time to produce sampled non-image sensor data; obtain a first set of encoded features for first semantic information associated with the sampled image sensor data; obtain a second set of encoded features for second semantic information associated with the sampled non-image sensor data; determine, based on a comparison of the first set of encoded features and the second set of encoded features to a third set of encoded features for semantic information associated with sampled data captured prior to the first time period, that there has been at least one change in the first semantic information or the second semantic information that exceeds a threshold value; submit, in response to determining that there has been at least one change in the first semantic information or the second semantic information that exceeds a threshold value, at least a portion of the first semantic information or the second semantic information in the form of a prompt to a large language model (LLM); and cause the device to perform an action based, at least in part, on an output from the LLM produced in response to the submitted prompt. (As mentioned above, in still other embodiments disclosed herein, the interpretation of the filtered semantics may be done directly in the embedded space, i.e., not submitting the semantics to be further processed by the LLM.)

According to some such embodiments, the data captured by the one or more image sensors over the first period of time comprises: still images, video segments, or a combination thereof. According to other such embodiments, the data captured by the one or more non-image sensors over the first period of time comprises: audio data, positional information, or a combination thereof.

According to still other embodiments, an image processing method is disclosed, comprising: sampling data captured by one or more image sensors of a device over a first period of time to produce sampled image sensor data; obtaining a first set of encoded features for first semantic information associated with the sampled image sensor data; sampling data captured by one or more non-image sensors of the device over the first period of time to produce sampled non-image sensor data; detecting, based on a comparison of the sampled data captured by the one or more non-image sensors over the first period of time to sampled data captured by the one or more non-image sensors over a period of time prior to the first period of time, that there has been at least one change in the data captured by the one or more non-image sensors; determining that: (a) based on a comparison of the first set of encoded features to a second set of encoded features for second semantic information associated with sampled data captured by the one or more image sensors of the device prior to the first time period, there has been at least one change in the first semantic information that exceeds a first threshold value; or (b) the at least one change in the data captured by the one or more non-image sensors exceeds a second threshold value; submitting, in response to determining that either the first threshold value or the second threshold value has been exceeded, at least a portion of the first semantic information or third semantic information that is associated with the sampled non-image sensor data in the form of a prompt to an LLM; and causing the device to perform an action based, at least in part, on an output from the LLM produced in response to the submitted prompt.

According to still other embodiments, one or more sensors of a device emit signals, which may be sampled and processed over a period of time. Then, the sampled signals may either be: (a) directly processed in their original domain to produce simple raw semantics (e.g., a determination whether a user is currently moving); or (b) transformed into raw semantics, e.g., using GenAI models. [Note: The raw semantics may be produced in the natural language domain or in an embedded domain. Semantics not already in an embedded domain may be transformed into an embedded domain for further processing, if so desired.] Next, a first volume of semantic information (e.g., spanning one or more sensors'data over a period of time preceding the moment in time when a final semantic output/system decision is needed), i.e., a “spatio-temporal semantic volume,” may be formed. Next, in order to produce a final semantic output, the first volume of semantic information may be further processed (e.g., filtered and/or fused) for the purposes of reducing redundancy, hallucinations, or computational requirements. The first volume of semantic information may be processed in embedded space, the natural language domain, or directly in signal space, as is appropriate. In some such embodiments, the sampled signals may comprise: depth information, IMU signals, and/or information from offline knowledge graphs/ontologies. The processed semantics may then be used by the system, e.g., to provide final, direct semantic output to the user at a given point in time and/or to input them to a machine that may perform subsequent actions based on further interpretation of such semantics.

Various other device, non-transitory computer-readable media (CRM) and method embodiments are also disclosed herein. Such CRM are readable by one or more processors. Instructions may be stored on the CRM for causing the one or more processors to perform any of the embodiments disclosed herein. Various electronic devices (e.g., wearable devices) are also disclosed herein, e.g., comprising memory, one or more processors, one or more image capture devices, displays and/or other electronic components (e.g., IMUs, microphones, etc.), and programmed to perform in accordance with the various method and CRM embodiments disclosed herein.

### BRIEF DESCRIPTION OF THE DRAWINGS

FIG. 1 illustrates an exemplary multi-sensor device processing pipeline for understanding environment and driving user experience (UX), according to one or more embodiments.

FIG. 2 illustrates a flowchart detailing a multi-sensor device processing pipeline for understanding environment and driving user experience (UX), according to one or more embodiments.

FIG. 3A illustrates a flowchart detailing an embedded space processing pipeline, according to one or more embodiments.

FIG. 3B illustrates a flowchart detailing another embedded space processing pipeline, according to one or more embodiments, according to one or more embodiments.

FIG. 4 is a flow diagram illustrating a method of performing multi-sensor processing and semantic generation to facilitate generative artificial intelligence-based device control and experiences, according to various embodiments.

FIG. 5 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

With the rise in availability of compact digital cameras in personal electronic devices (e.g., wearable devices) has come a rise in the need for more complex processing of the data captured by such electronic devices, including the performance of user interface-related and/or environmental understanding-based tasks and the providing of improved user experiences. In particular, such electronic devices may want to predict or determine the types of interactions that a user wishes to take with the electronic device, based on an analysis of the images in video image streams captured by a camera(s) of the electronic device. Such analysis may comprise the performance of: face detection (FD) algorithms, image understanding tasks, machine learning (ML)-based algorithms, three-dimensional (3D) scene understanding tasks, and/or 3D object understanding tasks on the captured images and other sensor data.

However, there remains an additional need for the ability to perform such user interface-related and/or environmental understanding-based tasks (and/or other types of tasks or user experiences) with greater efficiency and accuracy—and while leveraging information streams gathered by multiple types of input modalities (e.g., not solely captured video image stream data, but also the possibility of captured inertial measurement unit (IMU) data, individual still images, audio signals, or the like).

Performance of such user interface-related and/or environmental understanding-based tasks and user experiences desirably includes the ability to understand and compare gathered sensor data in a semantic way, filter out hallucinated or otherwise inaccurate data, and limit the amount of intensive data processing that needs to be performed in order for the device to have a natural and contextually-meaningful understanding of a user's activity and environment.

### A Multi-Sensor Device Processing Pipeline for Understanding Environment and Driving User Experience (UX)

As introduced above, embodiments disclosed herein include multi-sensor devices having processing pipelines with the aim of providing a better understanding of the user's environment and driving more intelligent and contextually-meaningful user experiences (UX) in a seamless fashion.

By acquiring and processing contemporaneous and synchronized data signals from multiple image and non-image sensors, and then intelligently filtering and fusing the inferred, noisy, fluctuating, (and, potentially, hallucinated) generated semantic information, the devices disclosed herein are able to produce more robust semantical information that can enable a more practical UX and “intelligent agent”capabilities.

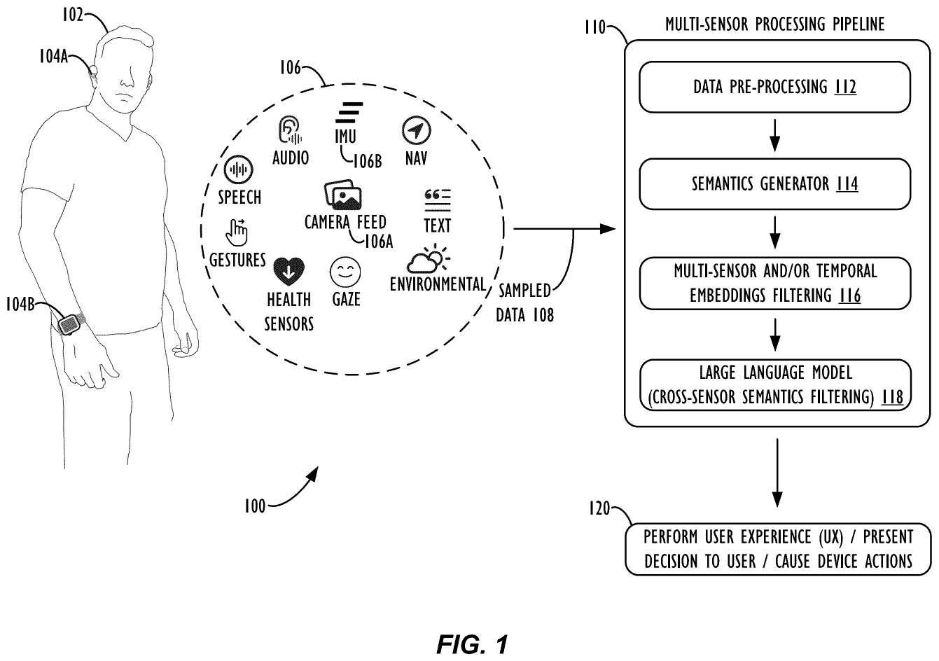

Turning first to FIG. 1, an example 100 of a multi-sensor device processing pipeline for understanding environment and driving user experience (UX) is shown, according to one or more embodiments. In the example 100 of FIG. 1, a user 102 is illustrated, wearing several electronic devices 104, e.g., headphones 104A and smart watch 104B. It is to be understood that the use of other electronic devices and other types of electronic devices is also possible, and devices 104A and 104B are shown for illustrative purposes only. In some embodiments, each such device 104 may comprise one or more image sensors (e.g., cameras), as well as one or more non-image sensors (e.g., microphones, IMUs, and the like).

Sensor group 106 shows various examples of types of sensors and signals that may be used in the multi-sensor device processing pipeline. For example, sensor group 106 may comprise: speech data, gesture data, health sensor data, gaze direction data, environmental data (e.g., weather, humidity, wind, etc.), textual data (e.g., OCR data), navigation data (e.g., GPS location), audio data, a camera feed 106A (producing a stream of still images and/or video data at a first sampling rate), and an IMU data feed 106B (producing a stream of device positional information at a second sampling rate, which may be different from the sampling rate of the camera feed or other sensors in the device sensor ecosystem).

As will be explained herein, the sensor group 106 data captured from the various devices 104 that are capturing sensor signals on behalf of a user are preferably sampled, synchronized, pre-processed, filtered, and then fused to provide a user with the most practical and contextually-relevant understanding of their environment and the ongoing changes thereto.

Turning now to the multi-sensor processing pipeline 110, the sampled data 108 from the various sensors in sensor group 106 may be obtained by the multi-sensor processing pipeline 110 for data pre-processing operations 112. According to some embodiments, the role of data pre-processing operations 112 may be two-fold: (1) to normalize the data input to the semantic generator 114; and (2) to format the data, i.e., in order to provide multiple ways in which the captured data can be presented to semantic generator 114.

According to some embodiments, particular data pre-processing operations 112 may include: performing horizon leveling on captured images (e.g., based on a gravity vector determined or inferred from IMU data); stitching together captured images from different camera or moments; performing image distortion correction; and/or cropping the data captured by one or more image sensors based on at least one of: an estimated attention (e.g., based on head pointing direction or gaze direction) of a user of the device during a first period of time; or a region of interest (ROI) identified in the data captured by the one or more image sensors. As may be appreciated, cropping or otherwise limiting the captured image data to only the parts of the captured scene that a user is likely to be paying attention to or perceiving allows the semantic generation models and LLMs to focus only on the relevant portions of the image data when performing their analysis, thereby reducing the amount of data being processed and improving the efficiency and relevancy of the LLM output.

The next step in the multi-sensor processing pipeline 110 may comprise passing the output of data pre-processing operation 112 to one or more semantics generators 114. Semantics generators 114 may be models trained to generate raw semantics based on the input data that they receive. For example, an image-based semantics generator may process an image of a room and output text such as, “A room with a TV in it” (or embeddings having an equivalent meaning). A non-image based semantic generator may process audio data and/or IMU data and output text such as, “Walking” or “Running” (or embeddings having an equivalent meaning). Examples of popular semantic generation models include, but are not limited to: CLIP, CLAP, BLIP, Human Activity Recognition (HAR) models, etc.

In some examples, pipeline 110 may have access to embeddings that can be extracted directly from a semantic encoder and used in a similarity measure (i.e., to compare one set of semantic information to another set of semantic information, as will be described in greater detail below). In other examples, however, pipeline 110 may need to decode the embeddings generated by the semantic encoder that was used and then re-encode them using a different encoder (e.g., depending on the particular model used).

As introduced above, the semantic information generated by a semantic model can generally take one of two forms: (1) an “embedded space” representation, i.e., a representation of the semantic information that is already in an encoded form and that can be extracted—but that may or may not be able to be used directly in a similarity measure computation; and (2) a “human-interpretable” representation, such as text, audio, etc., which may need to be decoded by a network from the embedded space and then transformed (i.e., encoded) again into a different embedded space, i.e., an embedded space where the computation of similarity measures between semantic embeddings from different sources is possible. (In other embodiments, transformation may not be necessary, e.g., depending on the embedded encoding used in a particular model.)

The next step in the multi-sensor processing pipeline 110 may comprise passing the output of the one or more semantics generators 114 to a temporal embedding filtering operation 116. As described above, according to some embodiments, it is preferable to compare sets of encoded features for semantic information associated with sampled data captured from different time periods to one another, i.e., to determine if there has been a significant or sufficient changes in semantics, such as to warrant further processing, e.g., by LLM model processing operations 118.

In some embodiments (and for some sensors), a significant change may be detected temporally (i.e., occurring over some period of time) directly in the embedded space. For other types of sensors, significant changes may be detected in the original signal domain. For still other types of sensors, significant changes by be detected using interpreted semantics for the sensor data (e.g., in the case of HAR models using IMU data).

By whatever methodology is employed, once a significant change in sensor data is detected, the embeddings from all the sensors corresponding to the time period when the change was detected in the embedded domain may be decoded and then bundled with any other relevant interpreted sensor semantics corresponding to the same time period and submitted, e.g., in the form of a prompt, for further processing by LLM model processing operations 118.

According to some examples, before submission to the LLM at block 118, the device may also detect and filter out any likely “hallucinations” in the semantic data, such that only the semantic information that is likely to be “valid” is bundled and submitted to the LLM. According to some such examples, the hallucination detection may be done by examining semantics temporally (e.g., using multiple sampling rates, such that, when a candidate change in semantics is detected at a first sampling rate, it may then also be validated, e.g., by examining semantics detected at a second sampling rate, to confirm that the but needs to also be validated that it is not a hallucination). In some embodiments, hallucination detection can also be performed by examining semantics across sensors (i.e., multi-sensor and multi-modal), as well as by examining semantics both across time and across different sensors and/or sensor types. Examining semantics may include utilizing similarity metrics and/or performing filtering operations on the semantic information.

The LLM may then fuse the (potentially multi-sensor/multi-modal) semantic information and produce a final semantic output, which, as shown at block 120, can be: (1) provided to the user in the direct form of context (e.g., information about the environment's composition, activities in the environment, or activities being performed by the user, etc.); (2) presented in the form of a decision, such as a classification of environment type (e.g., “kitchen”); or (3) provided to an automated process (e.g., in the form of a command submitted to an Internet of Things (IoT) device (e.g., turn on the lights”)). As used herein, the term “semantics” may refer to: (a) primitives, such as objects detected and their labels, text captions of an image or video, or a speech-to-text or audio-to-sound label; or (b) “interpreted semantics,” such as direct, descriptive, information presented to user in the form of text or audio data related to, e.g., what the user's environment is, what activity the user or someone in the environment is doing, or the condition of the environment, etc. Semantics may also include some decision about the user's state or the state of the environment or an activity, which may be communicated directly to user or to another device, in order to take further action.

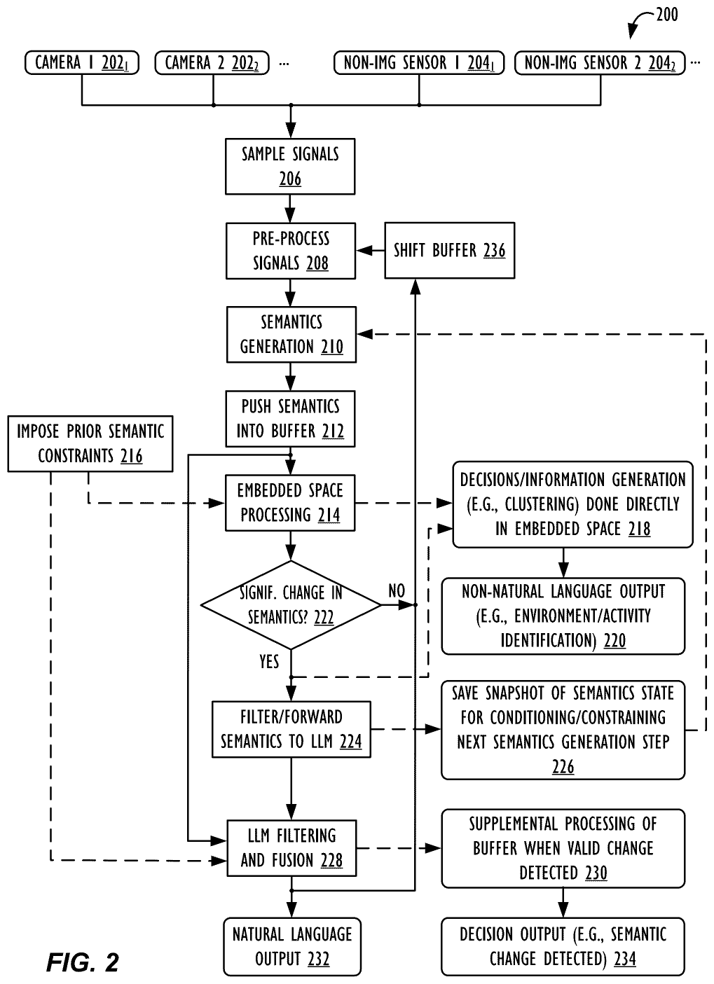

Turning now to FIG. 2, a flowchart detailing a multi-sensor device processing pipeline 200 for understanding environment and driving user experience (UX) is shown, according to one or more embodiments. As mentioned above, the fusion of multi-modal sensor data can provide devices with a richer and more contextually-relevant understanding of a user's activity and current environment. Thus, as shown at the top of flowchart 200, several exemplary image sensors (e.g., Camera 1 202₁ and Camera 2202₂), as well as several exemplary non-image sensors (e.g., Non-Image Sensor 1 204₁ and Non-Image Sensor 2 204₂), may be capturing data signals (e.g., still images, video segments, audio data, positional information, environmental data, or combinations thereof), e.g., the in the form of data streams at one or different data rates, which signals are indicative of the current environment around the user and/or around his or her relevant electronic device(s). In some embodiments, for non-image sensors, a change in sensor status may be detected based directly on its signal (i.e., not having to resort to first generating semantics and then detecting changes in the embedded space, as will be explained in further detail below). In such embodiments, the sensor output interpretation (i.e., semantics generation) may only need to be done if a sufficiently significant change in the signal was detected.

Next, at block 206, the various data signals may be sampled, in order to be in a condition wherein they may be used for further processing. For example, in some cases, sensors may be capturing data at a rate much faster than is needed for analysis by the multi-sensor device processing pipeline 200. In other cases, different sensors may be capturing data at different rates from each other, which data may need to be synchronized in time, such that samples from each sensor are associated with samples that correspond in time to the samples captured by each of the other sensor. In still other cases, the data sampling rate for a given sensor may be based on a type of mode, e.g., image capture mode, that a device is operating in (e.g., in a “passive” mode, new image data may be sampled at a regular interval, such as every X seconds; whereas, in an “active” mode, new image data may be sampled “on demand,” e.g., at an irregular interval and/or in response to some hardware or other sensor-driven signal).

Next, at block 208, signal pre-processing may be performed on the captured data. For example, as described above, pre-processing may help put each of the sampled signals into a form that is more amenable for further analysis, and may comprise operations such as: horizon leveling, distortion correction, cropping, scaling, rotation, etc.

In some alternative embodiments, additional image synthesis operations may be performed at block 208 to facilitate or enhance the semantics generation process at block 210. For example, image frames from multiple cameras may be geometrically stitched together into a panoramic image. This panoramic image could be then used by the semantics generator at block 210 to disambiguate the redundant appearance of the same object as captured by multiple ones of the individual cameras, and thus avoid counting such an object multiple times when generating the semantics for the observed scene. In other alternative embodiments, multiple images that are captured over some time interval may be stitched together and, e.g., combined with corresponding disparity information for later analysis by an LLM (or, alternatively, in embedded space), such that only a subset of the raw semantics that were generated in those images are analyzed, thereby helping to further refine the semantic interpretation operation. As described above, various semantic models or direct signal interpretation may use used at block 210 to generate the semantics for the pre-processed multi-modal signal data.

In some embodiments, semantic generators may be configured to generate a set number, N, of semantic outputs per input (e.g., per image), e.g., N=30. Then, hallucinated data can be removed from the generated semantics by observing the distribution of the semantic outputs in embedded space (i.e., the hallucinated semantics are more likely to be outliers in embedded space, as compared to the other semantics generated for the same input).

In other embodiments, segmented objects previously identified in the scene may be used as prior constraints to aid in the identification of likely semantic hallucinations in later-captured sensor data.

Next, at block 212, the semantic information may be pushed into a buffer, e.g., a ring buffer, or the like. In some embodiments, the buffer may comprise a first-in, first-out (FIFO) data structure, i.e., such that the semantic information is processed in a chronological order. (In some embodiments, e.g., wherein semantic information is interpreted directly from sensor data and/or no further embedded space processing is needed, the semantic information may be submitted directly to LLM filtering and fusion at block 228.)

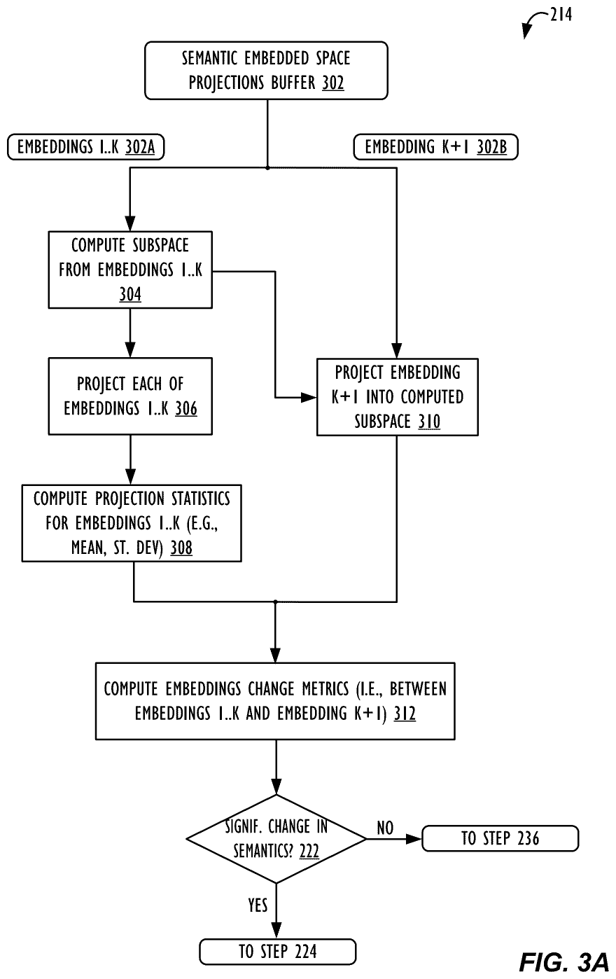

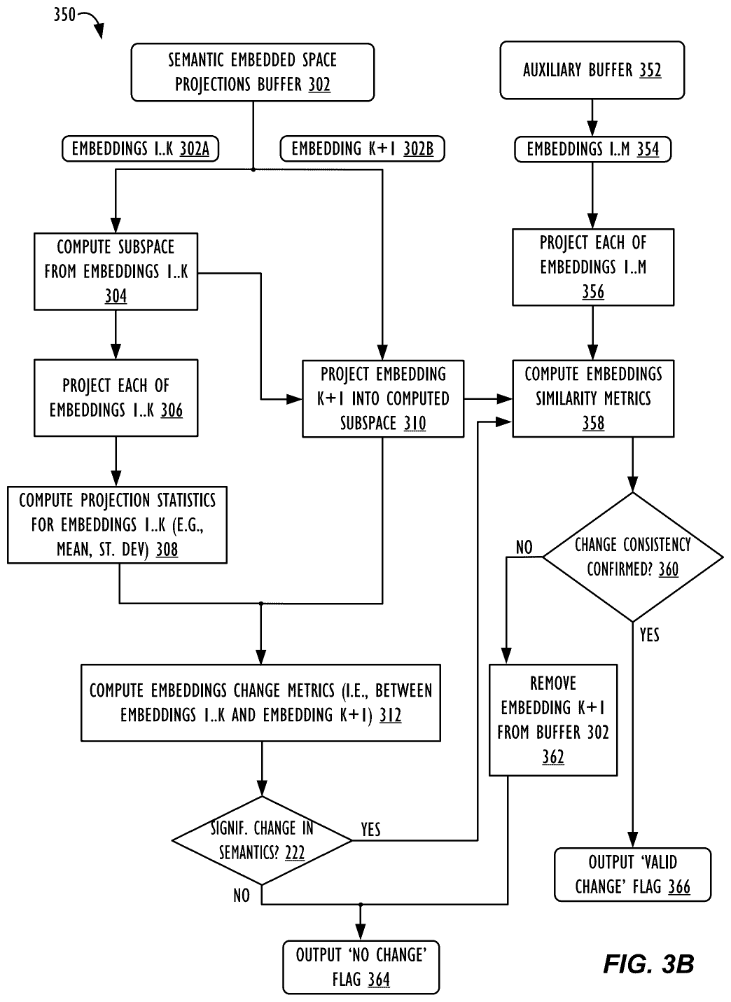

Next, at block 214, the semantic information may be processed in embedded space, i.e., embedded space processing (ESP), as will be described in further detail below, with reference to FIG. 3A and FIG. 3B. For example, as shown at block 218, the output of the ESP processing at block 214 may comprise various decision making/information generation (e.g., clustering) of the semantic generation that is done directly in embedded space. For example, new clusters of embeddings in ESP may be discovered/created as the system learns a user's frequent activities and/or environments over time. As mentioned above, in some embodiments, the output of the ESP at block 218 may lead to the device being able to directly take an output action in the embedded space (e.g., the identification of a user's environment and/or current activity) or other context-based notifications, suggested actions, or content to surface to the user, etc.

At block 222, one or more metrics may be applied to the semantic information in embedded space, e.g., a comparison of a distance in the embedded space between the current semantic information and the semantic information from a different (e.g., previous) time period against a similarity threshold value. If the comparison does not indicate a significant change in the underlying semantic information (i.e., “NO” at block 222), the pipeline 200 processing may return to block 236 (i.e., without activating the LLM), to shift the ring buffer of semantic information (i.e., pushing out the oldest data values) and then pre-process the next set of obtained data signals at block 208.

If, instead, the comparison does indicate a significant change in the underlying semantic information (i.e., “YES” at block 222), the pipeline 200 processing may proceed to block 224, to perform any additional filtering on the corresponding semantic information before submitting it to an LLM, e.g., in the form of a prompt. As mentioned above, the filtering of the semantic information may comprise the removal of noisy, fluctuating, and/or likely to be hallucinated (i.e., inaccurate) semantics. (In alternative embodiments, when the comparison indicates a significant change in the underlying semantic information (i.e., “YES” at block 222), the pipeline 200 processing may proceed to block 218 to make the relevant decisions directly in embedded space.)

According to some embodiments, the pipeline 200 processing may optionally proceed to block 226, to save a snapshot of the current state of semantic information. This state information may be used, e.g., for conditioning and/or constraining next semantics generation step (e.g., constraining the generation step, such that no more than a predetermined amount of change in semantics is allowed between successive sets of generated semantic information, using the current state to identify likely hallucinations, etc.).

In still other embodiments, as shown at block 216, the pipeline 200 processing may optionally apply additional prior semantic constraints at ESP block 214 and/or LLM filtering and fusion block 228. For example, these semantic constraints may be used to reduce hallucinations, constrain the universe of possible semantic signals that may be generated for the device at a given time/in a given environment, and/or apply any other personalized or custom/learned preferences regarding the semantics that are to be generated by a particular user, in a particular location or time, and/or when likely performing a particular activity.

According to some embodiments, the output of LLM filtering and fusion block 228 may comprise a natural language response at block 232. For example, a response such as, “You are looking at a room with a TV in it,” may be presented directly to the user of the device. In some alternative embodiments, an LLM need not be involved in the process, and the outputs could be taken directly from the ESP modules. According to such embodiments, the output of LLM filtering and fusion block 228 may optionally comprise, at block 230, supplemental processing of the semantic information buffer, e.g., to confirm when a valid change has been detected in the semantic information.

According to some such embodiments, the result of the supplemental processing as block 230 may comprise a decision output at block 234, e.g., based on the semantic change being detected and confirmed. For example, a decision, such as a determination that a user has moved into a room that is a kitchen, may be made by the device and used to drive any number of desired UX features based on the decision that the user has entered into a kitchen (e.g., turning on kitchen lights, turning on a stove, loading up a recipe for visual presentation to the user, etc.).

Preferably, the LLM is configured to be able to receive a variable number of semantic inputs from the multiple device sensors (e.g., 5 cameras, 3 IMUs, 2 microphones, and various environmental and health sensors), as some sensors may be prevented from sending information at given times/for given inputs (or at least thresholded, such that only data of sufficient quality is processed). In such cases, the LLM is preferable able to logically integrate these variable number of semantic inputs to produce the final semantic output. To further improve performance, the LLM can also be constrained by prior environmental information (along with ESP output), thereby limiting the scope of the possible semantic conclusions the LLM can reach, based on a given set of semantics.

In some embodiments, an output from the LLM produced in response to the prompt may be further constrained based on the content within at least one external ontology. In some such embodiments, the LLM's output may optionally be constrained by an external ontology containing a set of available options, e.g., as dictated by the user's current environment or activity. For example, the LLM may first determine a first condition (e.g., the user is currently located in a living room), and then, e.g., using the same LLM, it may be determined, based on the external ontology, that only a subset of possible actions could be being performed, based on the determined first condition (i.e., the first condition acts as an additional constraint). Returning to the above example, if the user is in a living room, it may be detected that he is currently watching TV, but other potential non-living room-related activities (e.g., playing basketball) could be ruled out, based on the determined first condition and information in the external ontology. As may now be appreciated, this ontological constraining may serve as an additional form of hallucination filtering.

### Exemplary Methods of Embedded Space Processing (ESP)

Turning now to FIG. 3A, a flowchart detailing an embedded space processing pipeline (and providing additional details to block 214 of FIG. 2) is shown, according to one or more embodiments. Looking first at step 302, a buffer of embedded space projections for the currently-being processed semantic information is obtained, having a size of K+1 embeddings here, for illustrative purposes. According to FIG. 3A, the first K embeddings, i.e., embeddings 1 . . . K (302A) may be separated from the currently-processed embedding, embedding K+1 (302B).

At block 304, a subspace may be computed from the embeddings 1 . . . K. Next, at block 306, each of the embeddings 1 . . . K may be projected into the embedded space. In some embodiments, it may be important to perform a dimensionality reduction operation on the embeddings (e.g., singular value decomposition, KSVD, PCA, learned model dimensionality reduction, or learned decomposition), i.e., to transform the data before further processing in embedded space. This dimensionality reduction may be important because comparison in the original dimensions of the embedded space (i.e., a high-dimensional space) may be extremely noisy.

At block 308, one or more desired projection statistics may be computed for the embeddings 1 . . . K. As may be appreciated, the computed projection statistics provide an average or general sense of where (in embedded space) the previous K semantic samples have been located. In order to compare the current embedding K+1 (302B) to the computed projection statistics from block 308, the method may first, at block 310, project the embedding K+1 into the computed subspace from block 304.

Next, at block 312, the method may compute embeddings change metrics (i.e., a metric representing the change in embedded space between embeddings 1 . . . K and the current embedding K+1), which may, e.g., involve performing a projection spread minimization operation.

Then, as described first above with reference to FIG. 2, if the comparison of projection statistics between embeddings 1 . . . K and embedding K+1 does not indicate a significant change in the underlying semantic information (i.e., “NO” at block 222), the pipeline 200 processing may return to block 236, to shift the ring buffer of semantic information (i.e., pushing out the oldest values) and then pre-process the next set of obtained data signals at block 208. If, instead, the comparison does indicate a significant change in the projection statistics between embeddings 1 . . . K and embedding K+1 (i.e., “YES” at block 222), the pipeline 200 processing may proceed to block 224, to perform any additional filtering on the corresponding semantic information before submitting it to an LLM, e.g., in the form of a prompt.

As mentioned above, in some embodiments, it may be preferable to refine the generated semantic information before submitting it to the LLM at block 224. In other words, rather than performing an “all-or-nothing” gating operation, a finer filtering operation can be performed that can remove outliers and give only a subset of the generated semantics to the LLM. This type of filtering may require some additional “look ahead” into the semantic data, but any increase in latency caused by the look ahead operation into the captured data may be offset by the increased filtering power (and, thus, increased accuracy) and the benefits of offloading the semantics filtering operations from the LLM.

In some embodiments, the embedded space representations may further be encapsulated in the form of an embedded space object (ESO). An ESO may comprise a collection of semantic labels generated, e.g., for a given image frame, and new ESOs may be stored for each captured image frame. Filtering operations may also be advantageously applied on the ESOs, i.e., in order to determine when there has been a significant change in the captured data in embedded space (i.e., versus a temporal inconsistency or hallucination, etc.). For example, according to one embodiment, an Exponential Moving Average (EMA) temporal filtering process may be applied, wherein the output of the EMA process is a list of objects that have a time-weighted confidence response above some threshold value. In other embodiments, a Semantic Clustering (SC) algorithm may be applied, wherein the embedding vectors of semantic information are used to update cluster statistics information, and wherein each incoming object's embedding vector is compared against the cluster information to compute a distance metric. When the computed distance metric for an incoming object is smaller than a distance threshold value, the object may be deemed to be semantically similar to the cluster (and may be kept for further processing), whereas incoming objects for which the computed distance metric is larger than the distance threshold value may be indicative of a change in the scene observed by the sensors, with substantially larger computed distance metrics being indicative of potential hallucinations.

Turning NOW to FIG. 3b, a flowchart detailing another embedded space processing pipeline 350 is shown, according to one or more embodiments. As illustrated, the left-half of FIG. 3B, including blocks 302-312 are identical to those blocks as illustrated and described above with reference to FIG. 3A, however, FIG. 3B illustrates the use of an additional or auxiliary buffer 352, whose role will be explained in greater detail below.

One aim of the use of the auxiliary buffer 352 is to further help the system to distinguish between legitimate semantics changes in any one camera or non-image sensor and outliers/hallucinations. One way this may be made possible is by introducing some additional latency in the filtering process, e.g., a “two-speed” process. For example, the sampling rate of a sensor (e.g., an image sensor) is likely too high to perform LLM submissions of all samples in real-time, but, it may be possible to perform ESP at this higher sampling rate, e.g., at defined time intervals, while the subsequent pipeline operations (e.g., LLM tasks, decision making, surfacing information to the UX, etc.) operate at lower rates.

Returning to the example 350 of FIG. 3B, auxiliary buffer 352 comprises embeddings 1 . . . M (354), wherein the number ‘M’ in this example may be larger than the number of ‘K’ embeddings referred to in FIG. 3A (and the left-half of FIG. 3B), i.e., the time interval of “looking ahead” at samples is longer. At block 356, each of embeddings 1 . . . M may be projected into the same computed subspace from block 304.

The extra M semantic samples that may be used to confirm a semantics change at a lower sampling rate at time K can be obtained following the current, i.e., K+1-th, semantic sample, i.e., a sample which may have triggered a change detected in the ESP, and may be taken at a higher sampling rate than the K samples were sampled at. Embedded similarity metrics computed at block 358 for the additional M samples may then be used to confirm at block 360 that the change detected at semantic sample time K+1 is indeed legitimate (i.e., “YES” at block 360), i.e., the change can be confirmed as “valid” at block 366 if it is sustained for another (higher-rate) M semantic samples following the K+1-th sample, and then the method may proceed to block 224 to proceed with further LLM processing of the sample(s). Note: This may also introduce additional latency in the response of the LLM to a change (in this case, a latency of one semantic sample at the lower sampling rate used for the first K samples).

Another implication of this extra validity check is that the LLM needs to be able to accept a variable number of semantic inputs at any point in time when it gets triggered. For example, if one camera's semantic change detection is declared not valid by the FIG. 3B process (i.e., “NO” at block 360), but another camera's change detection is declared as valid, then only the semantics of the legitimate/validly changing cameras should be submitted to the LLM. As shown at block 362, in response to a determination of “NO” at block 360, the process 350 may remove the outlier (i.e., non-legitimate semantics change) embedding K+1 from the buffer 302 and output a ‘no change’ flag at block 364 and then return to block 236 to shift the ring buffer, i.e., rather than sending it to the LLM and placing the burden of filtering out the non-legitimate sample on the LLM.

### Exemplary Methods of Multi-Sensor Processing and Semantic Generation to Facilitate Generative Artificial Intelligence-Based Device Control and Experiences

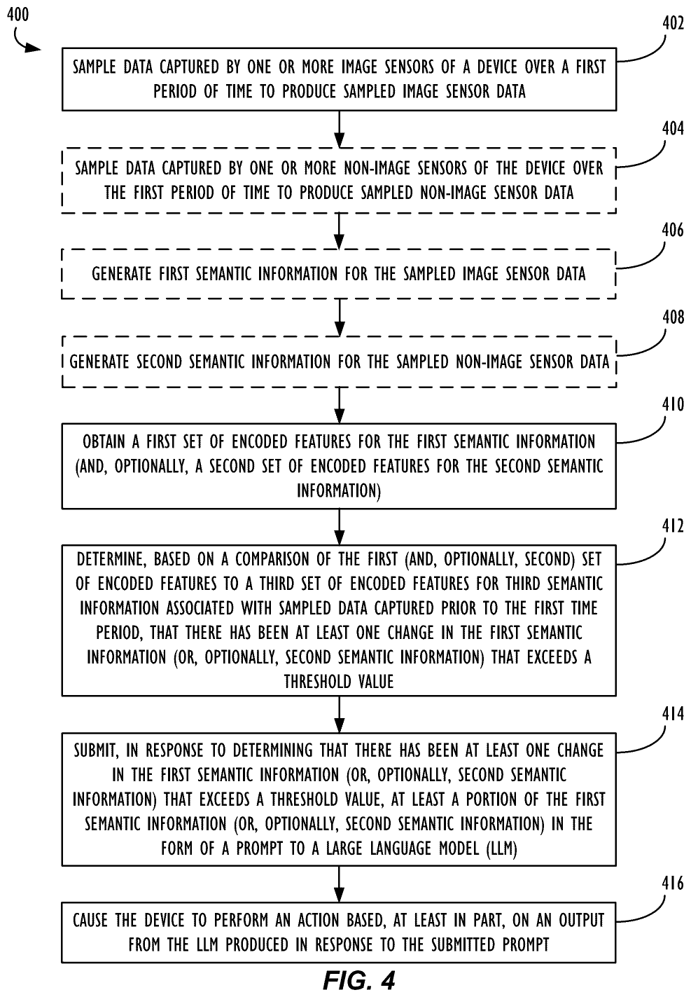

FIG. 4 is a flow diagram, illustrating a method 400 of performing multi-sensor processing and semantic generation to facilitate generative artificial intelligence-based device control and experiences, according to various embodiments. Method 400 provides a linear, high-level process flow diagram for the various features and processing pathways described above. First, at Step 402, the method 400 may sample data captured by one or more image sensors of a device over a first period of time to produce sampled image sensor data.

Next, at Step 404, the method 400 may optionally sample data captured by one or more non-image sensors of the device (e.g., IMUs, microphones, etc.) over the first period of time to produce sampled non-image sensor data. As mentioned above, preferably, the image and non-image sensor output sample are synchronized before analysis. For example, a “chunk” of IMU signal data may be sampled at a much higher rate than the typical 30 frames per second (fps) that a camera is sampled at, thus, individual IMU signal data may need to be synchronized with the captured video image frame(s) that it corresponds to temporally.

Next, at Step 406, the method 400 may optionally generate first semantic information for the sampled image sensor data. As mentioned above, in some cases, one or more models (e.g., CLIP, CLAP, BLIP, BLIP2, etc.) may be used to generate text descriptions for captured images or audio data.

Next, at Step 408, the method 400 may optionally generate second semantic information for the sampled non-image sensor data. As mentioned above, for some non-image sensors (e.g. IMUs), original captured signals may be interpreted in some way, e.g., using a human activity recognition (HAR) model, to generate semantics representing the activities that the model believes the IMU signals represent, such as “walking,”“climbing,”etc.

Next, at Step 410, the method 400 may obtain a first set of encoded features for the first semantic information (and, optionally, a second set of encoded features for the second semantic information). For example, the first and/or second set of encoded features may either be extracted directly (e.g., from CLIP or CLAP encoder embeddings), or they may be decoded (e.g., from CLIP or CLAP) and then re-encoded (e.g., using models such as BLIP, word2vec, etc.) to generate new embeddings that are more suited for comparisons.

Next, at Step 412, the method 400 may determine, based on a comparison of the first (and, optionally, second) set of encoded features to a third set of encoded features for third semantic information associated with sampled data captured prior to the first time period, that there has been at least one change in the first semantic information (or, optionally, second semantic information) that exceeds a threshold value. As mentioned above, in other embodiments, e.g., depending on the type of sensor signal used, the comparison may be performed in the original signal domain or by using interpreted semantics (i.e., rather than a comparison of encodings in embedded space).

Next, at Step 414, the method 400 may submit, in response to determining that there has been at least one change in the first semantic information (or, optionally, second semantic information) that exceeds a threshold value, at least a portion of the first semantic information (or, optionally, second semantic information) in the form of a prompt to a large language model (LLM). As mentioned above, in some embodiments, even if a change exceeding the threshold value is detected in one or more sensors at a particular time, hallucinations, noise, or other likely inaccurate (or redundant) data may first be filtered out, such that only the semantics that are likely to be “valid” are bundled and sent to the LLM. As may now be understood, the significant change detected in the semantic information at Step 412 can come from changes detected in one, multiple, or all of the image and non-image sensors that are being sampled in a given system, and a significant change in the data could have occurred at different instances in time for different sensors. In other words, performing the determination operation described in Step 412 may time place: across time for any one sensor; across sensors at any one time; or combinations thereof.

Finally, at Step 416, the method 400 may cause the device to perform an action based, at least in part, on an output from the LLM produced in response to the submitted prompt. As mentioned above, in some embodiments, the action may be: (1) providing natural language text output to the user (e.g., information about the environment's composition, activities in the environment, or activities being performed by the user, etc.); (2) making some form of a decision, such as a classification of environment type (e.g., “kitchen”); or (3) making (or causing some other device to make) an automated process (e.g., turning on lights in a room, turning off a stove, launching a particular application, etc.). It is to be understood that, in other embodiments, the decisions, actions, or context provided to user as a result of the semantic processing performed by a particular electronic device associated with a user (e.g. a mobile phone), may alternatively be at least partially performed and/or provided to another device associated with the user (e.g., a peripheral device, a wearable device, another electronic device, etc.), such as headphones 104A and smart watch 104B, shown in FIG. 1, or even another smart device in the user's ecosystem, such as a television, thermostat, etc. In other words, the effects of the action performed at Step 416 are not limited to taking place exclusively at the device that does the reasoning/processing itself. Similarly, the image and/or non-image sensor data obtained and processed by the user's electronic device may be obtained from any number of peripheral devices in communication with the user's electronic device.

### Additional Examples

As described above and with reference to method 400, the multi-sensor processing pipelines described herein may normally be used to generate semantics for submission to an LLM. However, alternatively, the processing pipeline may also leverage additional (e.g., offline-constructed) ontologies of items, e.g., objects of interest that may belong dominantly in a particular environment, type of environment, in association with certain types of user (i.e., egocentric) activities, or activities of users or objects in the environment, in order to constrain the possible outputs of the processing pipeline (and the LLM). In other words, the LLM may only get to choose its output from the set of available options dictated by the ontology. Additionally, specific prompt constructions may be used with the LLM to achieve this goal (i.e., the goal of obtaining constrained output relevant to a particular task/environment).

In other examples, the multi-sensor processing pipeline may be able to operate without the use of an LLM. In such examples, the role of the LLM's decision making in the pipeline may be replaced by a classification task, which, e.g., may leverage a Bayesian belief propagation (BBP) module. In such examples, an LLM may be used offline to generate a likelihood-weighted ontology of objects belonging to a particular environment(s) (e.g., in a bedroom, there may be a likelihood-weighted ontology of objects, such as: {bed, 0.98}, {lamp, 0.82}, etc.). Then, at decision time in the processing pipeline, the BBP module may take in this information and put it together with: image or non-image sensor data, frame captions, detected object labels, and/or previous classifications/predictions to make a probabilistic decision of what that user's environment might be at the current time.

In still other examples, when performing a classification task, the LLM may make errors in predicting the correct environment (e.g., room type). For a given prompt submitted to the LLM, the predictions of the LLM could be ranked by prediction confidence. For all the predictions with confidence levels below a threshold value, a BBP module may be used instead to predict the environment.

In yet another example, rather than (or in addition to) the sensors gathering information and performing reasoning on that information “online” (i.e., in real time) as has been primarily described in the examples above, environmental information may also be gathered beforehand, but the result of any reasoning performed on such data over time may only be output or used at a later point in time, e.g., in response to a user query, when a particular condition is met at the device, or in response to a specific environment-context detection by the pipeline, etc.

The various methods described herein, e.g., with reference to FIG. 3A-3B, and 4 may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s). In some implementations, one or more of the processing steps may also be performed by a device that is remote to the electronic device, e.g., on a smartphone, laptop or other electronic device associated with the user, and/or on a server device accessible to the electronic device via a network connection (which server device may, e.g., have greater processing capacity than a wearable electronic device).

### Exemplary Electronic Computing Devices

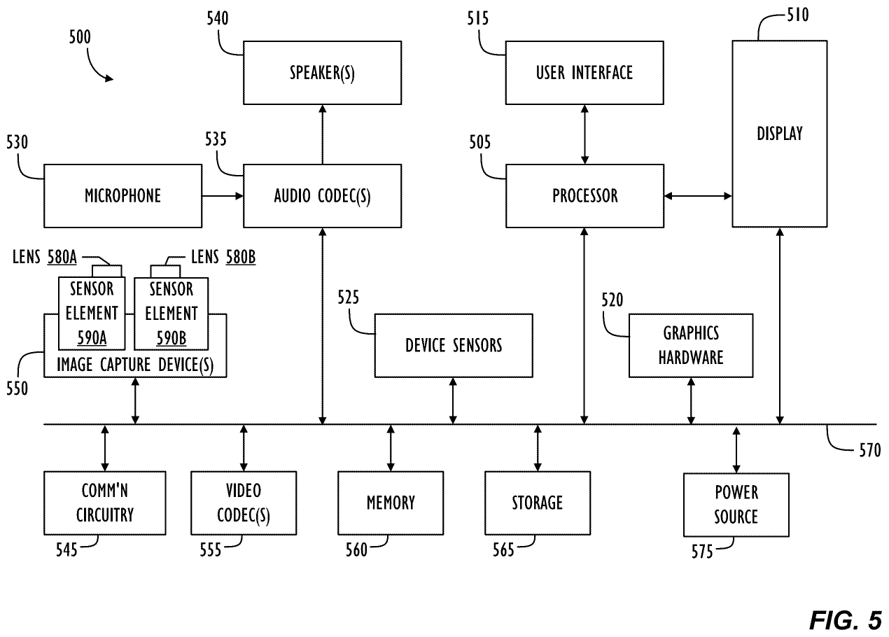

Referring now to FIG. 5, a simplified functional block diagram of illustrative programmable electronic computing device 500 is shown according to one embodiment. Electronic device 500 could be, for example, a mobile telephone, personal media device, portable camera, or a tablet, notebook or desktop computer system. As shown, electronic device 500 may include processor 505, display 510, user interface 515, graphics hardware 520, device sensors 525 (e.g., proximity sensor/ambient light sensor, accelerometer, inertial measurement unit, and/or gyroscope), microphone 530, audio codec(s) 535, speaker(s) 540, communications circuitry 545, image capture device 550, which may, e.g., comprise multiple camera units/optical image sensors having different characteristics or abilities (e.g., Still Image Stabilization (SIS), HDR, OIS systems, optical zoom, digital zoom, etc.), video codec(s) 555, memory 560, storage 565, and communications bus 570.

Processor 505 may execute instructions necessary to carry out or control the operation of many functions performed by electronic device 500 (e.g., such as the generation, processing, and/or streaming of image and non-image sensor data, in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 510 may display a video stream as it is captured while processor 505 and/or graphics hardware 520 and/or image capture circuitry contemporaneously generate and store the video stream in memory 560 and/or storage 565. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 550 may comprise one or more camera units configured to capture images, e.g., images which may be processed to generate cropped, augmented, and/or distortion-corrected versions of said captured images, e.g., in accordance with this disclosure. Image capture device(s) 550 may include two (or more) lens assemblies 580A and 580B, where each lens assembly may have a separate focal length. For example, lens assembly 580A may have a shorter focal length relative to the focal length of lens assembly 580B. Each lens assembly may have a separate associated sensor element, e.g., sensor elements 590A/590B. Alternatively, two or more lens assemblies may share a common sensor element. Image capture device(s) 550 may capture still and/or video images. Output from image capture device 550 may be processed, at least in part, by video codec(s) 555 and/or processor 505 and/or graphics hardware 520, and/or a dedicated image processing unit or image signal processor incorporated within image capture device 550. Images so captured may be stored in memory 560 and/or storage 565.

Memory 560 may include one or more different types of media used by processor 505, graphics hardware 520, and image capture device 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory;
one or more image sensors; and
one or more processors operatively coupled to the memory, wherein the one or more processors are configured to execute instructions causing the one or more processors to:
sample data captured by the one or more image sensors over a first period of time to produce sampled image sensor data;
obtain a first set of encoded features for first semantic information associated with the sampled image sensor data;
determine, based on a comparison of the first set of encoded features to a second set of encoded features for second semantic information associated with sampled data captured prior to the first time period, that there has been at least one change in the first semantic information that exceeds a threshold value;
submit, in response to determining that there has been at least one change in the first semantic information that exceeds a threshold value, at least a portion of the first semantic information in the form of a prompt to a large language model (LLM); and
perform an action at the device based, at least in part, on an output from the LLM produced in response to the submitted prompt.

2. The device of claim 1, further comprising one or more non-image sensors, wherein the one or more processors are further configured to execute instructions causing the one or more processors to:
sample data captured by the one or more non-image sensors over the first period of time to produce sampled non-image sensor data; and
obtain a third set of encoded features for third semantic information associated with the sampled non-image image sensor data,
wherein the instructions causing the one or more processors to determine, based on a comparison of the first set of encoded features to a second set of encoded features for second semantic information associated with sampled data captured prior to the first time period, that there has been at least one change in the first semantic information that exceeds a threshold value further comprise instructions causing the one or more processors to:
determine, based on a comparison of the first set of encoded features and the third set of encoded features to the second set of encoded features, that there has been at least one change in the first semantic information or the third semantic information that exceeds a threshold value, and
wherein the instructions causing the one or more processors to submit, in response to determining that there has been at least one change in the first semantic information that exceeds a threshold value, at least a portion of the first semantic information in the form of a prompt to an LLM further comprise instructions causing the one or more processors to:
submit, in response to determining that there has been at least one change in the first semantic information or the third semantic information that exceeds a threshold value, at least a portion of the first semantic information or the third semantic information in the form of a prompt to an LLM.

3. The device of claim 1, wherein the LLM comprises a multimodal LLM.

4. The device of claim 1, wherein the one or more processors are further configured to execute instructions causing the one or more processors to:
pre-process the sampled image sensor data based on training data that was used to train a first encoder network, wherein the pre-processing occurs prior to using the first encoder network to produce the first set of encoded features.

5. The device of claim 1, wherein the one or more processors are further configured to execute instructions causing the one or more processors to:
process the sampled image sensor data captured by the one or more image sensors over a first period of time using at least one image processing technique prior to using a first encoder network to produce the first set of encoded features.

6. The device of claim 1, wherein the instructions causing the one or more processors to sample data captured by the one or more image sensors over a first period of time further comprise instructions causing the one or more processors to:
crop the data captured by the one or more image sensors based on at least one of: an estimated attention of a user of the device during the first period of time; or a region of interest (ROI) identified in the data captured by the one or more image sensors.

7. The device of claim 1, wherein the data captured by the one or more image sensors over the first period of time comprises: still images, video segments, or a combination thereof.

8. The device of claim 1, wherein the first set of encoded features is produced, at least in part, by
applying one or more constraints to the first semantic information based on the second set of encoded features.

9. The device of claim 1, wherein the action comprises at least one of: a natural language output; or a programmatic decision output.

10. The device of claim 1, wherein the first semantic information comprises at least one of: textual information; or semantic information encoded in an embedded space.

11. The device of claim 1, wherein the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to:
filter out at least a second portion of the first semantic information from the submission to the LLM based on the second portion of the first semantic information being at least one of: noisy, inaccurate, or redundant.

12. The device of claim 1, wherein the instructions causing the one or more processors to sample data captured by the one or more image sensors over a first period of time further comprise instructions causing the one or more processors to perform at least one of the following:
sample data captured by the one or more image sensors at a regular time interval;
sample data captured by the one or more image sensors at an irregular time interval; or
sample data captured by the one or more image sensors in response to one or more detected conditions at the device.

13. The device of claim 2, wherein the one or more processors are further configured to execute instructions causing the one or more processors to:
determine, based on at least one signal, when during the first time period to sample from data captured by the one or more image sensors; and
determine, based on at least one signal, when during the first time period to sample from data captured by the one or more non-image sensors.

14. The device of claim 1, wherein the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to:
constrain an output from the LLM produced in response to the prompt based on at least one external ontology.

15. The device of claim 1, wherein the instructions causing the one or more processors to submit, in response to determining that there has been at least one change in the first semantic information that exceeds a threshold value, at least a portion of the first semantic information in the form of a prompt to a large language model (LLM) further comprise instructions causing the one or more processors to:
filter out at least a second portion of the first semantic information based, at least in part, on a determination that the at least second portion of the first semantic information comprises hallucinated semantic information.

16. The device of claim 2, wherein the instructions causing the one or more processors to submit, in response to determining that there has been at least one change in the first or third semantic information that exceeds a threshold value, at least a portion of the first or third semantic information in the form of a prompt to a large language model (LLM) further comprise instructions causing the one or more processors to:
filter out at least a second portion of the first or third semantic information based, at least in part, on a determination that the at least second portion of the first or third semantic information comprises hallucinated semantic information.

17. A non-transitory program storage device comprising instructions stored thereon to cause one or more processors to:
sample data captured by one or more image sensors of a device over a first period of time to produce sampled image sensor data;
sample data captured by one or more non-image sensors of the device over the first period of time to produce sampled non-image sensor data;
obtain a first set of encoded features for first semantic information associated with the sampled image sensor data;
obtain a second set of encoded features for second semantic information associated with the sampled non-image sensor data;
determine, based on a comparison of the first set of encoded features and the second set of encoded features to a third set of encoded features for semantic information associated with sampled data captured prior to the first time period, that there has been at least one change in the first semantic information or the second semantic information that exceeds a threshold value;
submit, in response to determining that there has been at least one change in the first semantic information or the second semantic information that exceeds a threshold value, at least a portion of the first semantic information or the second semantic information in the form of a prompt to a large language model (LLM); and
cause the device to perform an action based, at least in part, on an output from the LLM produced in response to the submitted prompt.

18. The non-transitory program storage device of claim 17, wherein the data captured by the one or more image sensors over the first period of time comprises: still images, video segments, or a combination thereof.

19. The non-transitory program storage device of claim 18, wherein data captured by the one or more non-image sensors over the first period of time comprises: audio data, positional information, or a combination thereof.

20. An image processing method, comprising:
sampling data captured by one or more image sensors of a device over a first period of time to produce sampled image sensor data;
obtaining a first set of encoded features for first semantic information associated with the sampled image sensor data;
sampling data captured by one or more non-image sensors of the device over the first period of time to produce sampled non-image sensor data;
detecting, based on a comparison of the sampled data captured by the one or more non-image sensors over the first period of time to sampled data captured by the one or more non-image sensors over a period of time prior to the first period of time, that there has been at least one change in the data captured by the one or more non-image sensors;
determining that: (a) based on a comparison of the first set of encoded features to a second set of encoded features for second semantic information associated with sampled data captured by the one or more image sensors of the device prior to the first time period, there has been at least one change in the first semantic information that exceeds a first threshold value; or (b) the at least one change in the data captured by the one or more non-image sensors exceeds a second threshold value;
submitting, in response to determining that either the first threshold value or the second threshold value has been exceeded, at least a portion of the first semantic information or third semantic information that is associated with the sampled non-image sensor data in the form of a prompt to an LLM; and
causing the device to perform an action based, at least in part, on an output from the LLM produced in response to the submitted prompt.
